(19) United States
(12) Patent Application Publication
(10) Pub. No.: US 2018/0348141 A1
(43) Pub. Date: Dec. 6, 2018

(54) PHOTON COUNTING IN LASER INDUCED BREAKDOWN SPECTROSCOPY

(71) Applicant: Peter HARDMAN, Woburn, MA (US)

(72) Inventor: Peter HARDMAN, Woburn, MA (US)

(73) Assignee: Olympus Scientific Solutions Americas Inc., Waltham, MA (US)

(21) Appl. No.: 15/954,685

(22) Filed: Apr. 17, 2018

Related U.S. Application Data
(60) Provisional application No. 62/512,203, filed on May 30, 2017.

(51) Int. Cl. G01N 21/71; G01J 3/443; G01J 1/44

(52) U.S. Cl. CPC G01N 21/718; G01J 3/443; G01J 2001/442; G01N 2201/06113; G01J 1/44

(57) ABSTRACT

A compact, low cost device for laser induced breakdown spectroscopy (LIBS) makes use of a silicon photomultiplier detector and a photon counting method.

### CROSS-REFERENCE TO RELATED APPLICATIONS

This application claims the benefit and priority of U.S. Provisional patent application Ser. No. 62/512,203 filed May 30, 2017 entitled PHOTON COUNTING IN LASER INDUCED BREAKDOWN SPECTROSCOPY, the entire disclosure of which is incorporated herein by reference.

### FIELD OF THE INVENTION

The invention relates in general to laser induced breakdown spectroscopy (LIBS) and in particular to a photon counting apparatus and method for use in LIBS.

### BACKGROUND OF THE INVENTION

LIBS is a form of atomic emission spectroscopy which uses an energetic laser pulse focused on a test object, the laser pulse forming a plasma which vaporizes and excites atoms of the test object. After a delay time for cooling the plasma, characteristic photon radiation emitted by the excited atoms is detected and measured, thereby identifying and quantifying elements present in the test object.

LIBS desktop or laboratory equipment is known in the art, however there is a need for compact, portable, robust and low cost equipment which may be deployed to measure elemental concentrations in field conditions. In general, the laser power of such compact equipment is lower than the power available in desktop or laboratory equipment. Consequently, the rate of production of characteristic photons is lower, and it is important to select a photon detection system which has high efficiency and high gain, while still being robust, compact and low cost.

In existing practice, photon detection in LIBS is done with a charge sensitive detection system which detects electrons generated by photons reaching a detector. Electrons accumulated during a detection time after each laser pulse are collected, often with a capacitive collector, and the accumulated charge is added to charge accumulated from previous pulses. The disadvantage of this method is that the accumulated charge is proportional to the number of incident photons only if the gain is constant throughout the measurement and if the number of events is large enough to provide adequate statistics. However, because the gain of all detection systems may change due to changes of temperature or other variables in the system electronics, the charge per pulse will vary even for photons of the same energy. Therefore, the method of charge accumulation in existing practice is an unreliable method of quantifying the number of incident photons.

### SUMMARY OF THE INVENTION

Accordingly, it is a general objective of the present disclosure to have photon detection apparatus and methods which are suitable for a compact, low-cost, portable LIBS instrument.

It is further an objective of the present disclosure to have a photon detector which meets the requirements for a compact, low-cost, portable LIBS instrument.

It is further an objective of the present disclosure to have a photon counting method which meets the requirements for a compact, low-cost, portable LIBS instrument, and which reliably quantifies the number of incident photons, thereby quantifying an elemental concentration in a test object.

The foregoing requirements are achieved using a silicon photomultiplier (SiPM) detector which is used to count photons emerging from a spectrometer transmitting a selected portion of the wavelength distribution of photons emitted from the test object.

### BRIEF DESCRIPTION OF THE DRAWINGS

FIG. 1 is a schematic representation of a LIBS instrument according to the present disclosure.

FIG. 2A is a schematic representation of a method of LIBS analysis by counting photons according to the present disclosure.

FIG. 2B is a schematic representation of an alternative embodiment of a method of LIBS analysis by counting photons according to the present disclosure.

FIG. 3 is a schematic representation of a method of LIBS analysis by accumulating charge in existing practice.

### DETAILED DESCRIPTION OF PREFERRED EMBODIMENT

The following photon detector types are known in existing practice:
Avalanche Photo Diode (APD)—This detector has gain of 10⁴ to 10⁵, which is insufficient for use in LIBS. In addition, the gain is unstable because it is sensitive to temperature.
Photo Multiplier Tube (PMT)—This detector has high gain (˜10⁷). However it is too large, bulky and expensive for use in a compact LIBS system. Since it comprises a glass tube, the PMT is fragile, and it requires a high bias voltage of typically 1,000 to 2,000V.
Channel Photon Multiplier (CPM)—This detector, comprising a glass tube, is bulky and fragile. It also is not readily commercially available.
Charge Coupled Device (CCD)—This is a one- or two-dimensional detector array which has high cost and slow readout speed. Also, it is not possible to gate a CCD so that measurement is blocked during the delay time after a laser pulse.
Micro-channel Plate Image Intensifier—This is a one- or two-dimensional detector array which is fragile, being made of glass. It also has high cost, and requires a high bias voltage of 500V or more.

In contrast to the above mentioned detectors, a silicon photomultiplier (SiPM) is an inexpensive detector with a high gain of 10⁶ to 10⁷. Comprising a small piece of silicon, it is robust and compact, typically having a sensitive area of about 1 mm². Because a SiPM continuously detects photons and does not need to be read out like a CCD, it is easy to provide a gating signal which blocks measurement of photons during the delay time after a laser pulse.

A potential disadvantage of a SiPM is that, at high photon count rates, if two or more photons are incident on the detector within the detector pulse rise time, then only one event will be recorded and counts may be lost. This phenomenon is known as pulse “pileup”. However, taking into account the relatively low count rates expected with a small laser in a portable device, and the fast rise time of the output pulse from a SiPM, loss of photon counts from pileup events may be neglected.

It should be noted that use of a SiPM detector for a portable LIBS device is a key aspect of the present disclosure.

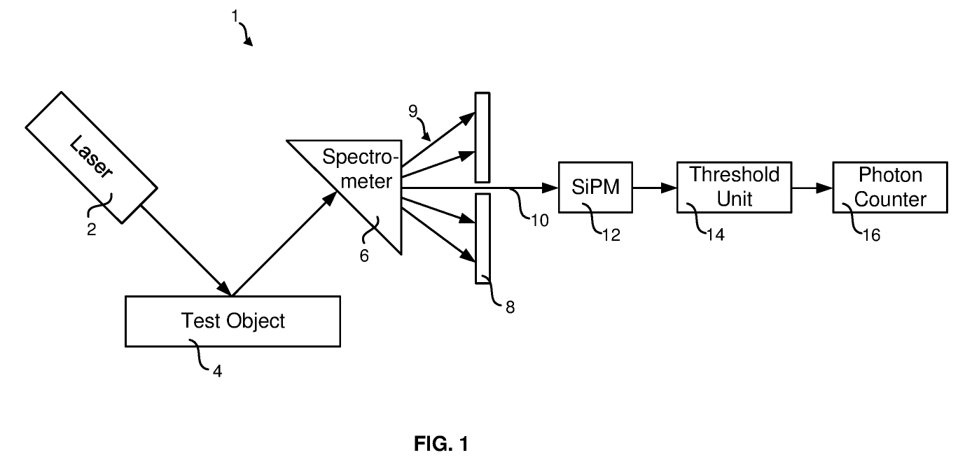

FIG. 1 is a schematic representation of a LIBS instrument 1 according to the present disclosure. Pulses of laser energy from a laser 2, each pulse having a pulse trigger time, are focused on to the surface of a test object 4. Atoms from test object 4 are vaporized and excited, emitting characteristic photons which are transported to a wavelength dispersive spectrometer 6. Spectrometer 6 is configured to spatially disperse the photons according to their wavelength, forming a wavelength dispersed spectrum 9. Wavelength dispersive spectrometers are well known in the art and may comprise glass prisms or other wavelength dispersive elements. A wavelength selector 8, which may be an aperture or any other optical device, is configured to select a selected wavelength portion 10 of wavelength dispersed spectrum 9. Selected wavelength portion 10 may comprise wavelengths associated with the characteristic photon emission of one or more particular elements of test object 4. Photons of selected wavelength portion 10 are transported to a SiPM detector 12 which produces a pulse for each incident photon in selected wavelength portion 10. The pulses are passed to a threshold unit 14 configured to determine whether the amplitude of each pulse surpasses a measurement noise threshold. Pulses with amplitude greater than the threshold are then counted by a photon counter 16, the counting commencing after a fixed delay time subsequent to each laser pulse trigger time, and continuing for a fixed sampling time. Use of a delay time is known in the art, its purpose being to allow decay of Bremsstrahlung radiation due to energetic electrons. In an embodiment, the delay time may be about 100 nanoseconds and the sampling time may be about 100 microseconds. However any values of delay time and sampling time are possible, and all values are within the scope of the present disclosure.

SiPM detector 12, threshold unit 14 and photon counter 16 may be configured to count incident photons for a fixed number of laser pulses, in which case the total count of photons is a measure of the elemental concentration corresponding to wavelength portion 10. Alternatively, SiPM detector 12, threshold unit 14 and photon counter 16 may be configured to count incident photons until a fixed number of photons have been counted, in which case the total number of laser pulses is a measure of the elemental concentration corresponding to wavelength portion 10.

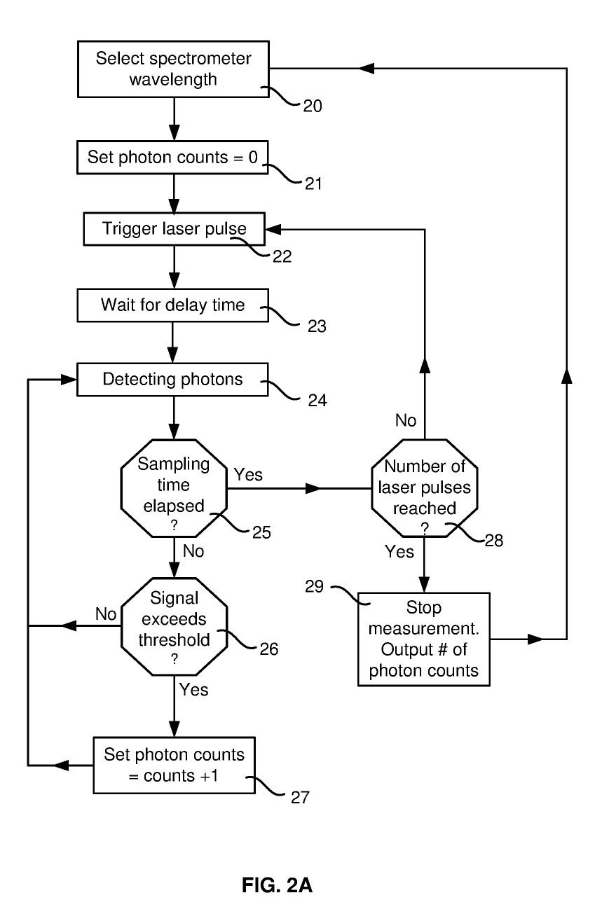

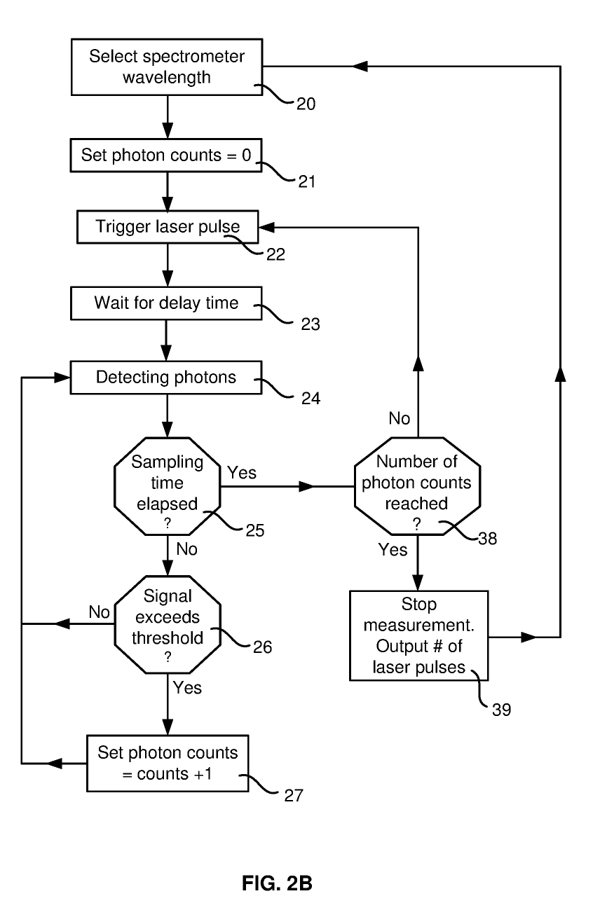

FIG. 2A is a schematic representation of a method of LIBS analysis by accumulating photon counts according to the present disclosure. In step 20, spectrometer 6 and wavelength selector 8 are configured to select selected wavelength portion 10 which may correspond to a particular element to be measured in test object 4. In step 21 the photon count is set to zero. In step 22, a pulse from laser 2 is triggered, causing photon emission from test object 4. Step 23 is waiting for the delay time, after which, in step 24, SiPM detector 12 begins to detect signals from photons transmitted by spectrometer 6 and arriving at detector 12. Step 25 is a check whether the sampling time after the current laser pulse has elapsed. If not, step 26 checks whether each signal exceeds a noise threshold, and if so the photon count is incremented by one at step 27. Having incremented the count at step 27, or if the signal does not exceed threshold at step 26, photon detection continues at step 24. If at step 25, the sampling time has elapsed, step 28 checks whether a fixed number of laser pulses has been reached with the current wavelength selection. If not, another laser pulse is triggered at step 22. If the fixed number of laser pulses has been reached, measurement at the current wavelength selection stops at step 29 and the number of photon counts is output as a measurement of the elemental concentration corresponding to the current wavelength. Optionally, the method may then return to step 20 for selection of a different wavelength corresponding to a different element of test object 4.

FIG. 2B is a schematic representation of an alternative embodiment of a method of LIBS analysis by counting photons according to the present disclosure. In the method of FIG. 2B, steps 20-27 are the same as the method of FIG. 2A. However, if the sampling time has elapsed at step 25, step 38 checks whether a fixed number of photon counts has been reached with the current wavelength selection. If not, another laser pulse is triggered at step 22. If the fixed number of photon counts has been reached, measurement at the current wavelength selection stops at step 39 and the number of laser pulses is output as a measurement of the elemental concentration corresponding to the current wavelength. Optionally, the method may then return to step 20 for selection of a different wavelength corresponding to a different element of test object 4.

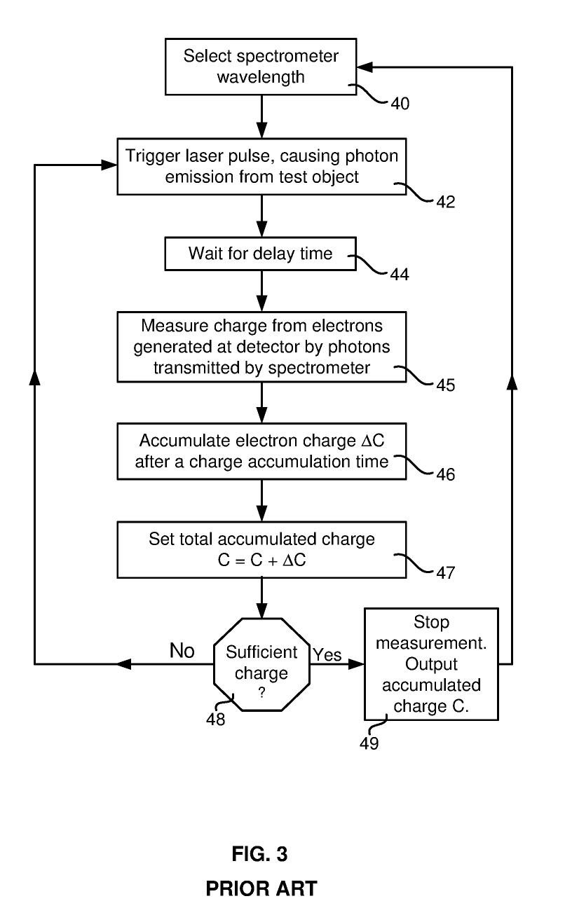

FIG. 3 is a schematic representation of a method of LIBS analysis by accumulating charge in existing practice. In step 40, a spectrometer is configured to select a particular wavelength portion. In step 42, a pulse from a laser is triggered, causing photon emission from a test object. Step 44 is waiting for a delay time, after which, in step 45, a detector begins to measure charge from electrons generated by photons transmitted by the spectrometer and arriving at the detector. In step 46, the electron charge is accumulated for a charge accumulation time, the accumulated charge being designated C. In step 47, the charge AC from the current laser pulse is added to the total accumulated charge C from all previous pulses when the spectrometer is at the current wavelength selection. Step 48 checks whether total accumulated charge C is sufficient for the current wavelength selection. If so, the measurement stops at step 49, and total accumulated charge C is output as a measurement of the elemental concentration corresponding to the current wavelength. Optionally, the method may then return to step 40 for selection of a different wavelength corresponding to a different element of the test object. If, at step 48, the accumulated charge is not sufficient, the method may return to step 42 to trigger another laser pulse.

Note that the method of existing practice shown in FIG. 3 is an analog method in which the elemental concentration corresponding to the selected spectrometer wavelength is represented by an analog accumulation of charge. This method suffers from the disadvantage that if the detector gain changes, for example due to temperature changes, the measured total accumulated charge C will also change, even for the same number of photons. On the other hand the methods according to the present disclosure and shown in FIGS. 2A and 2B are digital methods in which the elemental concentration corresponding to the selected spectrometer wavelength is measured by digital accumulations of photon counts and laser pulses. The advantage of the methods according to the present disclosure is that, since the spectrometer has already selected the photons of interest, the task of the detector may be limited to only counting events that exceed the measurement noise threshold. For pulses above the noise threshold, it is not necessary to measure the size of individual pulses from the detector, in contrast to the method of existing practice where deposited charge from each pulse must be measured with an integrating detector, such as a CCD. Therefore, counting photons according to the method of the present disclosure is not subject to errors due to gain changes of the detector and associated electronics. Moreover, at the relatively low count rates expected with a small laser in a portable device, and taking into account the fast rise time of the output pulse from a SiPM, pileup of pulses can be neglected.

Note that the use of photon counting for a portable LIBS device is a key aspect of the present disclosure.

It should also be noted that the method of photon counting is enabled by use of a SiPM detector because of the SiPM detector's high gain, fast rise time, small size and low bias voltage requirement. The high gain means that the signal to noise ratio is high, the fast rise time reduces pileup events, and the small size and lower voltage requirements make it easier to implement in a small portable device.

Although the present invention has been described in relation to particular embodiments thereof, it can be appreciated that various designs can be conceived based on the teachings of the present disclosure, and all are within the scope of the present disclosure.

What is claimed is:

1. An instrument for determining an elemental concentration of an element in a test object using laser induced breakdown spectroscopy (LIBS), the instrument comprising:
a photon detector configured to receive photons and to produce photon pulse signals, each of the photon pulse signals corresponding to a one of the photons; and,
a photon counter configured to receive the photon pulse signals and to count a total photon count.

2. The instrument of claim 1 further comprising a laser configured to emit laser pulses of laser power to a surface of the test object, each laser pulse having a trigger time, the laser emitting a total laser pulse number of pulses during a measurement time, the laser power causing emission of the photons from atoms of the test object.

3. The instrument of claim 2 further comprising a wavelength dispersive spectrometer configured to receive the photons and to spatially disperse the photons according to a wavelength of each photon, thereby forming a wavelength dispersed spectrum of the photons.

4. The instrument of claim 3 further comprising a wavelength selector configured to transmit selected photons having a selected wavelength portion of the wavelength dispersed spectrum, wherein the selected wavelength portion substantially corresponds to a characteristic wavelength of the element.

5. The instrument of claim 4 wherein the photon detector is configured to receive the selected photons and each of the photon pulse signals corresponds to a one of the selected photons.

6. The instrument of claim 1 wherein the photon detector is a silicon photomultiplier.

7. The instrument of claim 2 wherein the total photon count is an accumulated number of photon pulse signals received by the photon counter during the measurement time.

8. The instrument of claim 7 wherein the measurement time is a laser pulse time, wherein the laser pulse time is a time for the laser to emit a predetermined number of pulses.

9. The instrument of claim 8 wherein the total photon count is proportional to the elemental concentration.

10. The instrument of claim 7 wherein the measurement time is a photon count time, wherein the photon count time is a time for the photon counter to count a predetermined total photon count.

11. The instrument of claim 10 wherein the total laser pulse number is proportional to the elemental concentration.

12. The instrument of claim 1 wherein the instrument is a portable instrument.

13. A method of determining an elemental concentration of an element in a test object using laser induced breakdown spectroscopy (LIBS), the method comprising the steps of:
detecting photons with a photon detector configured to receive the photons and to produce photon pulse signals, each of the photon pulse signals corresponding to a one of the selected photons; and,
counting a total photon count with a photon counter.

14. The method of claim 13 further comprising the step of emitting laser pulses of laser power to a surface of the test object, each laser pulse having a trigger time, the laser emitting a total laser pulse number of pulses during a measurement time, the laser power causing emission of the photons from atoms of the test object.

15. The method of claim 14 further comprising the step of receiving the photons at a wavelength dispersive spectrometer configured to spatially disperse the photons according to a wavelength of each photon, thereby forming a wavelength dispersed spectrum of the photons.

16. The method of claim 15 further comprising the step of transmitting selected photons having a selected wavelength portion of the wavelength dispersed spectrum, wherein the selected wavelength portion substantially corresponds to a characteristic wavelength of the element.

17. The method of claim 16 wherein the photon detector is configured to receive the selected photons and each of the photon pulse signals corresponds to a one of the selected photons.

18. The method of claim 13 wherein the photon detector is a silicon photomultiplier.

19. The method of claim 14 wherein the total photon count is an accumulated number of photon pulse signals received by the photon counter during the measurement time.

20. The method of claim 19 wherein the measurement time is a laser pulse time, wherein the laser pulse time is a time for the laser to emit a predetermined number of pulses.

21. The method of claim 20 wherein the total photon count is proportional to the elemental concentration.

22. The method of claim 19 wherein the measurement time is a photon count time, wherein the photon count time is a time for the photon counter to count a predetermined total photon count.

23. The method of claim 22 wherein the total laser pulse number is proportional to the elemental concentration.

24. The method of claim 16 wherein the instrument is a portable instrument.
